(19) United States
(12) Patent Application Publication
(10) Pub. No.: US 2019/0135502 A1
(43) Pub. Date: May 9, 2019

(54) VACUUM INSULATED BEVERAGE CONTAINER WITH REMOVABLE CUP AND METHOD OF USING THE SAME

(71) Applicant: Igloo Products Corp., Katy, TX (US)

(72) Inventor: Vincent Tsai, Quincy, MA (US)

(21) Appl. No.: 15/970,299

(22) Filed: May 3, 2018

Related U.S. Application Data
(60) Provisional application No. 62/581,430, filed on Nov. 3, 2017.

(51) Int. Cl. B65D 43/16; A47J 41/02; A47J 41/00; B65D 41/26; B65D 51/18

(52) U.S. Cl. CPC B65D 43/165; A47J 41/028; A47J 41/0072; B65D 2251/1025; B65D 51/18; B65D 2251/0003; B65D 41/26

(57) ABSTRACT

A vacuum insulated container includes a body defined with inner and outer walls, a lid portion having a cap that is arranged to be actuated between open and closed states, and a removable cup that has a threaded connection to the body. Upon the cup being engaged with the body, an interior surface of the cup may contact the cap, or be arranged in proximity to the cap, in order to maintain the cap in the closed state. When the cup is removed from the body, the cap may be actuated between the open and closed states. In the open state, fluid may be accessed through an opening in the lid portion, where the opening conforms to a user's mouth to facilitate drinking. The fluid also may be poured from the container into the cup, which may include a liner or foam insulation.

### CROSS-REFERENCE TO RELATED APPLICATION(S)

The present application claims the benefit of U.S. Provisional Patent Application No. 62/581,430 filed Nov. 3, 2017, the entire contents of which are incorporated by reference herein.

### BACKGROUND

### (a) Technical Field

The present disclosure relates to a vacuum insulated container including a lid portion with a cap and a removable cup, and more particularly, to the vacuum insulated container in which the removable cup is configured to substantially prevent the cap from being opened when the removable cup is connected to the container.

### (b) Description of the Related Art

Generally, containers may include a mechanism for opening and closing an aperture through which fluid may enter and/or exit the container (e.g., a screw-on cap, a flip cap, etc.). To access the fluid within the container, a user would typically move or remove a portion of the cap or lid relative to the aperture of the container, so that a fluid path into the container may be provided and/or accessed.

A vacuum insulated container is typically made of metal, in which a vacuum is formed between inner and outer walls of the container. In particular, a stainless steel double walled vacuum bottle can provide suitable insulating properties to maintain the fluid contained in the bottle at a desired temperature. Such containers may include a removable cup that is press fit to the top of the container. However, the removable cup typically is not attached in a secure manner, and also does not provide any sealing function with respect to the closing mechanism of the container.

It would be desirable to provide a vacuum insulated container having a simple closing mechanism that is additionally secured by engagement between a removable cup and the closing mechanism.

### SUMMARY

According to the present disclosure, a vacuum insulated container includes a body defined with inner and outer walls, a lid portion having a cap that is arranged to be actuated between open and closed states, and a removable cup that has a threaded connection to the body, such that when the cup is removed, it is possible to access fluid contained within the body of the container.

In particular, according to the present disclosure, a vacuum insulated container may include: a body made of metal having inner and outer walls with a vacuum formed between the inner and outer walls, the body having a top and a bottom defined at opposite ends, the inner wall forming a cavity configured to receive fluid therein; a lid portion in fluid communication with the top of the body, the lid portion having a cap configured to be actuated between an open state and a closed state, such that in the open state, the fluid can enter or exit the body; and a removable cup being connected to the body so as to cover the lid portion and maintain the cap in the closed state.

The cap may be a flip-top cap configured to be toggled manually between the open and closed states. In particular, upon removal of the cup from the container, the cap is configured to be opened or closed. The cap may be configured to pivot relative to a remainder of the lid portion so as to engage or release a latch mechanism. Preferably, in the open state of the cap, an opening of the lid portion is uncovered to enable entry or exit of the fluid in the body, the opening having a shape that facilitates pouring or drinking from the opening, where the opening may be semicircular in shape.

The body of the container preferably is made of stainless steel, and the lid portion is connected to the body via a threaded connection. In particular, the lid portion includes external threads configured to engage with internal threads of the body.

The cup is configured to be threaded to the body. In particular, the cup includes inner threads and a rim, the inner threads configured to engage with corresponding outer threads of the body, and the rim configured to contact a surface of the body. Further, the cup is configured to be threaded to the body such that at least a portion of an inner surface of the cup may contact an upper surface of the cap so as to maintain the cap in the closed state. Alternatively, a gap may be formed between the inner surface of the cup and the upper surface of the cap to prevent overtightening of the cup. The cup may be foam insulated or formed with a liner, where the liner preferably includes a plurality of channels to provide insulative properties.

Also, according to the present disclosure, a method of using a vacuum insulated container may include steps of: providing a body made of metal having inner and outer walls with a vacuum formed between the inner and outer walls, the body having a top and a bottom defined at opposite ends, the inner wall forming a cavity configured to receive fluid therein; removing a cup from the container by unscrewing the cup from the body, so as to remove the cup from blocking or obstructing access to the cap, thereby exposing a lid portion of the container, the lid portion being in fluid communication with the top of the body; and actuating a cap arranged on the lid portion, the cap configured to be actuated from a closed state to an open state with the cup removed from the body, such that in the open state of the cap, the fluid can enter or exit the body.

### BRIEF DESCRIPTION OF THE DRAWINGS

For a fuller understanding of the nature and desired objects of the present disclosure, reference is made to the following detailed description taken in conjunction with the accompanying drawing figures wherein like reference characters denote corresponding parts throughout the several views and wherein:

FIG. 1 is a front view of a vacuum insulated container with a cup attached to the container according to an embodiment of the present disclosure;

FIG. 2 is a cross-sectional view of the vacuum insulated container of FIG. 1;

FIG. 3 is a perspective view of a vacuum insulated container in which the cup has been removed and a cap in a closed state;

FIG. 4 is a perspective view of the vacuum insulated container of FIG. 3 in which the cap is in an open state;

FIG. 5 is an enlarged cross-sectional view of a lid portion of the vacuum insulated container of FIG. 1;

FIG. 6A is an enlarged cutaway perspective view of the lid portion of the vacuum insulated container of FIG. 3 in which the cap in the open state;

FIG. 6B is an enlarged cutaway perspective view of the lid portion of the vacuum insulated container of FIG. 3 in which the cap is in a partially closed state;

FIG. 7 is an enlarged cross-sectional view of the lid portion of the vacuum insulated container of FIG. 3 in which the cap is in the partially closed state;

FIG. 8 is an enlarged isolated perspective view of a cup as removed from a vacuum insulated container;

FIG. 9 is a front view of a vacuum insulated container with a cup attached to the container according to an alternate embodiment of the present disclosure;

FIG. 10 is a cross-sectional view of the vacuum insulated container of FIG. 9; and

FIG. 11 is an enlarged cross-sectional view of a lid portion of the vacuum insulated container of FIG. 9, including a call-out depicting separation between an inside of a cup and a top of a cap.

### DEFINITIONS

Hereinafter reference will now be made in detail to various embodiments of the subject disclosure, examples of which are illustrated in the accompanying drawings and described below. While example embodiments are described, it will be understood that the present disclosure is not limited to those exemplary embodiments. On the contrary, this disclosure covers not only the embodiments described herein, but also various alternatives, modifications, equivalents and other embodiments, which may be included within the spirit and scope of the disclosure.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

As used herein, the singular form “a”, “an” and “the” include plural references unless the context clearly dictates otherwise.

### DETAILED DESCRIPTION OF THE DISCLOSURE

Referring now to embodiments of the present disclosure, the disclosed container features a drink-through design (i.e., a fluid path is formed from a body through a lid portion, allowing a user to drink fluid inside the container simply by actuating a cap, i.e., without removing the lid portion, that is both leak-proof by way of a pivoting closure mechanism that reversibly seals an opening in the container lid, the closure mechanism being additionally secured by presence of a cup that is threaded to the body so as to cover the lid portion and maintain the cap in the closed state. The result is a cap arranged on a lid portion that prevents leakage of fluid within the container while also preserving the temperature of said fluid, e.g., by virtue of use of a vacuum sealed container. The disclosed container also features a thread pattern which may be fashioned to face outwardly with respect to the cup, so as to couple with an inwardly facing thread pattern of the cup, thereby creating a tight seal that increases leak prevention and insulative properties of the lid portion. Further, the cup may include foam insulation within its walls in order to provide additional insulative properties.

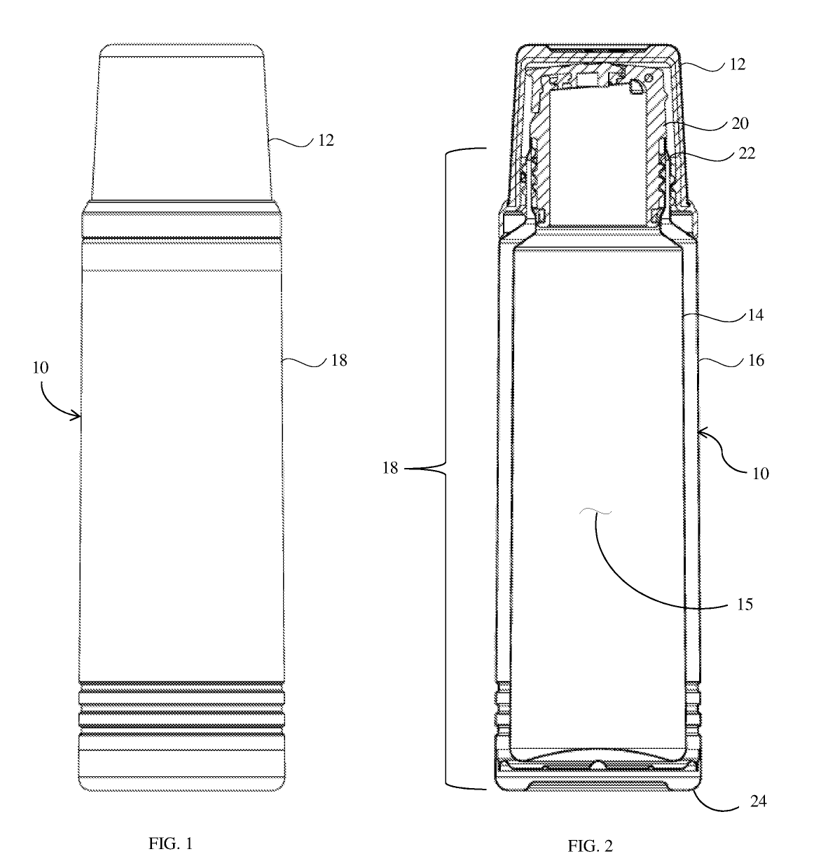

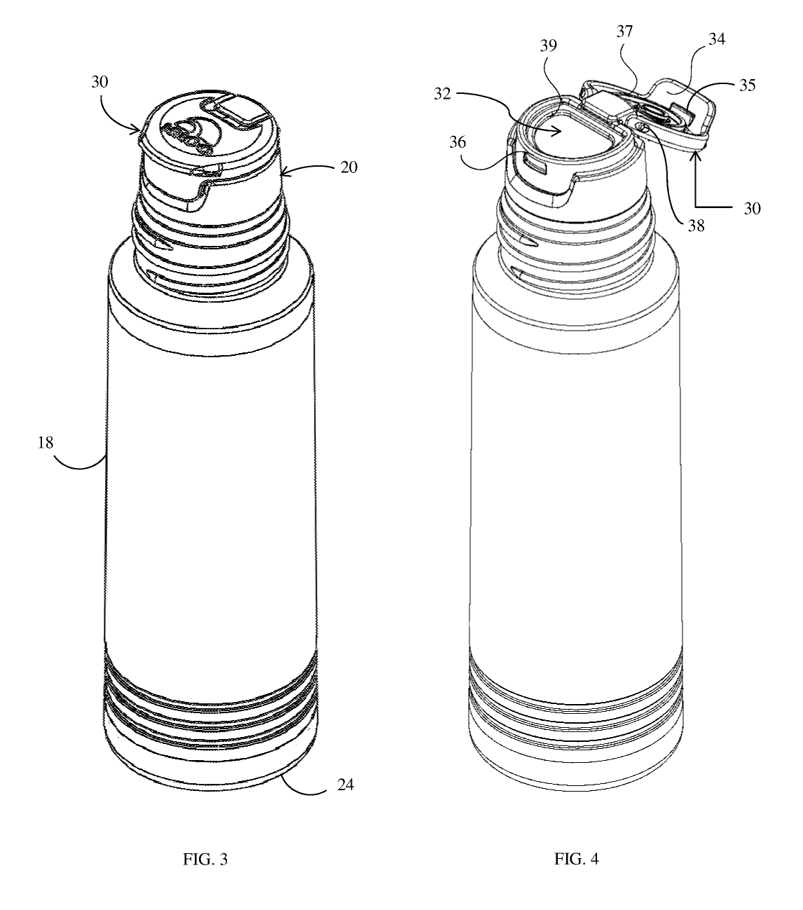

FIGS. 1-2 depict a container 10 including a removable cup 12 operably connected to the container 10. The container 10 preferably is a vacuum insulated container, and includes a body 18 made of metal, e.g., stainless steel. The body 18 is includes an inner wall 14 and an outer wall 16, such that a gap is formed between the inner and outer walls 14, 16 in which air is evacuated, thus forming a vacuum. By virtue of the use of vacuum insulation, a fluid provided in the container can be maintained at temperature (e.g., hot or cold) for a longer period of time, as compared to other types of insulation. The body 18 is configured to hold fluid therein, in particular, within a cavity 15 defined by the inner wall 14. The body 18 is in fluid communication with a lid portion 20 at a top end 22 of the body 22. An opposite end (i.e., bottom end 24) of the body 18 forms a base of the container 10.

The lid portion 20 is depicted in greater detail in FIGS. 3-4, 6A-6B, and 7, in which the cup 12 has been removed from the container 10. By removing the cup 12 from the container 10, it is possible to open/close the cap 30. FIGS. 3 and 4 depict closed and open states, respectively, of a cap 30. In particular, once the cup 12 is removed from the container 10, the cap is configured to be actuated between a closed state (see FIG. 3) and an open state (see FIG. 4), such that in the open state, fluid can enter or exit the container 10 via an opening 32. For example, the cap 30 can be a flip-top cap that is configured to be toggled manually between the closed and open states, as shown in FIGS. 3-4, respectively.

Preferably the opening 32 has a shape that facilitates pouring and/or drinking from the opening 32, e.g., a semicircular shape as shown in FIG. 4. However, any suitable shape (e.g., oblong, circular, etc.) that enables the user to consume fluid from the container 10 will suffice. Conventional stainless steel vacuum containers often include a screw cap covering a small circular opening as the closure mechanism, which may be suitable for pouring, but is not shaped and/or sized to permit a user to drink directly from the cap. However, according to the disclosure as provided herein, preferably the shape of the opening 32 conforms approximately to a user's mouth, and thus enables the user to consume fluid from the container 10 by placing the user's mouth directly over the opening 32. Alternatively, the opening 32 can have a larger circular shape that permits directly consuming fluid from the opening 32, as distinguished from simply pouring fluid via the opening 32.

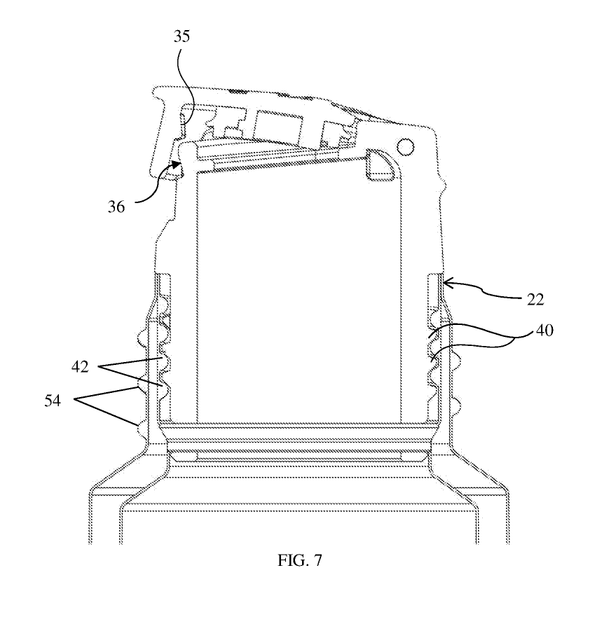

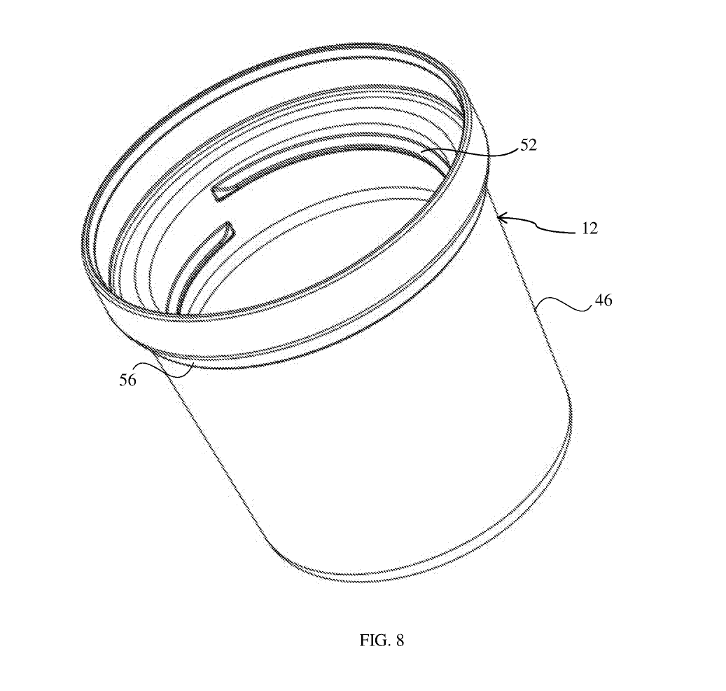

A closing mechanism of the cap 30 is shown in FIG. 4, for example. Referring to FIG. 4, the cap 30 preferably includes a simple closing mechanism, in which one side of the cap 30 includes a hinge 38, and the other side of the cap 30 includes an upper portion 34 with a detent 35 or the like that is configured to engage with a corresponding notch 36 or the like formed in a base portion (i.e., remainder) of the lid 20, thereby forming a latch mechanism. The latch mechanism thus is arranged to pivot the upper portion 34 between the closed state (FIG. 3) and the open state (FIG. 4), thereby allowing the cap 30 to be closed and opened easily. The arrangement of the detent 35 and the notch 36 is shown in greater detail in FIG. 7. The cap 30 additionally is formed with a sealing ring 37, e.g., made of silicone, that is configured to engage an outer portion 39 of the opening 32 when the latch mechanism is engaged in the closed state. In particular, the sealing ring 37 is shaped so as to conform with the shape of the opening 32, and thus may be substantially semicircular in shape in the embodiment depicted in FIGS. 3-4.

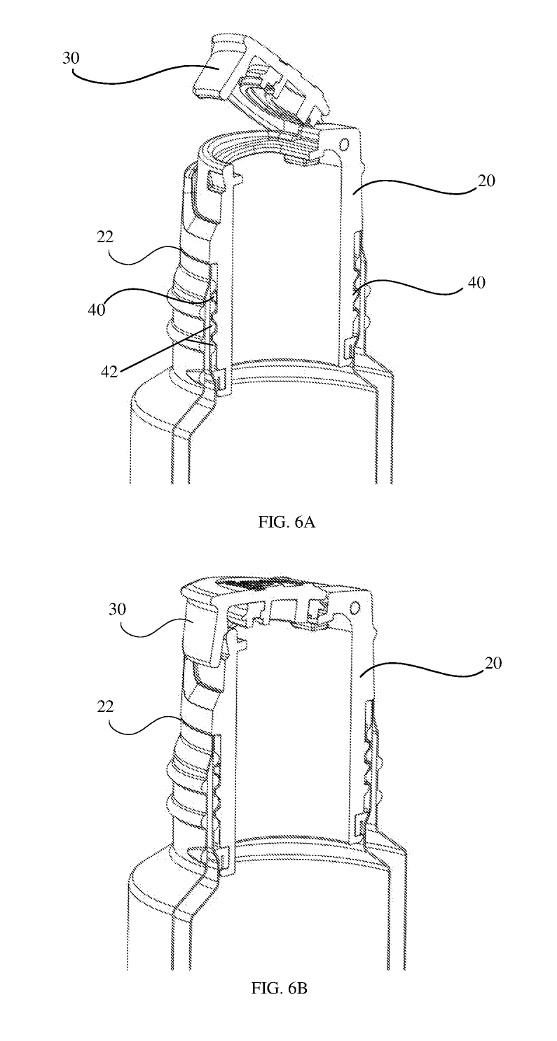

According to the present disclosure, the lid portion 20 is connected to the body 18 via a threaded connection, as shown in FIGS. 6A-6B and 7. In particular, the lid portion 20 includes external threads 40 configured to engage with internal threads 42 of the body 18. Therefore, the lid portion 20 is removable from the body 18, for example, for cleaning. While the body 18 preferably is made of stainless steel, the lid portion 20 may be fashioned using any suitable material, such as polypropylene (PP) or other thermoplastic polymers, for example. In particular, the lid portion 20 may be injection molded as a separate component from the body 18.

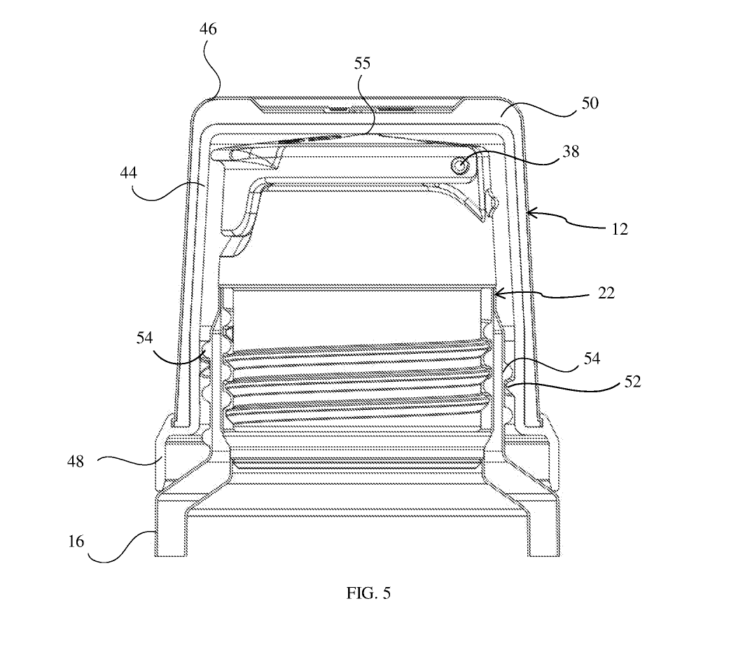

Details of a configuration of the cup 12 will now be described with reference to FIGS. 1, 2, 5, and 8. As shown in FIG. 5, for example, the cup 12 preferably includes an inner portion 44 and an outer portion 46, where the inner portion 44 protrudes outwardly to form a rim 48 (see also FIG. 8). Alternatively, the rim 48 may extend from the inner portion 44 or be formed as a separate component that is welded or otherwise attached to the inner and/or outer portions 44, 46. When the cup 12 is received on the body 18 of the container 10, the rim 48 is configured to contact at least a portion of the outer wall 16 of the body 18. In other words, the rim 48 is configured to rest against a surface of the outer wall 16 circumferentially around the outer wall 16 of the body 18. In addition, a tapered area 56 is formed adjacent to the rim 48 to facilitate holding the cup via the user's fingers. The inner and outer portions 44, 46 of the cup 12 may be fashioned using any suitable material, such as acrylonitrile butadiene styrene (ABS) or other thermoplastic polymers, for example.

Referring to FIG. 5, the cup 12 preferably includes foam insulation 50 formed between the inner and outer portions 44, 46. Different varieties of foam may be utilized for insulation in the cup 12, such as expanded polystyrene (EPS) or the like, and the foam insulation 50 may be inserted into the body of the cup 12 using various techniques known in the art such as foam injection molding or the like. The foam insulation 50 may be inserted within one of the portions of the cup 12, and the inner and outer portions 44, 46 may then be adjoined (e.g., ultrasonically welded) to produce the foam insulation-filled cup 12. The foam insulation 50 may be disposed within the cup 12 using any suitable techniques known in the art. The foam insulation 50 can fill an entirety of a hollow body of the cup 12, thereby enhancing insulative properties of the cup 12.

The cup 12 is configured to be threaded to the body 18. For example, as shown in FIG. 5, the cup 12 includes at least one inner thread 52 configured to engage with outer threads 54 of the body 18 (see also FIG. 7). When the cup 12 is threaded to the body 18, as shown in FIG. 5, contact may be established between a surface 55 of the inner portion 44 of the cup 12 and a top of the cap 30, thereby maintaining the cap 30 in the closed state. By virtue of this contact between the cup 12 and the cap 30, additional sealing capability is provided, because the cap 30 is prevented from inadvertently becoming unlatched, and thus is maintained in the closed state. In addition, as shown in FIG. 5, when the cup 12 is fully engaged with the body 18 of the container 10, the rim 48 of the cap 12 rests against a surface of the outer wall 16 of the body 18, thereby substantially preventing the escape of any fluid contained within the cup 12.

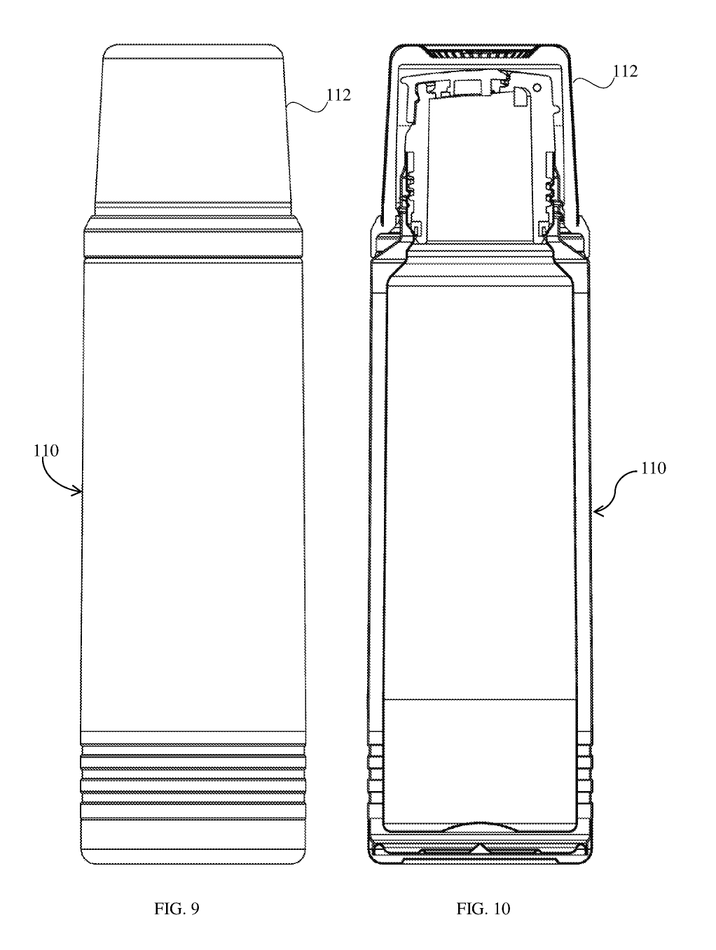

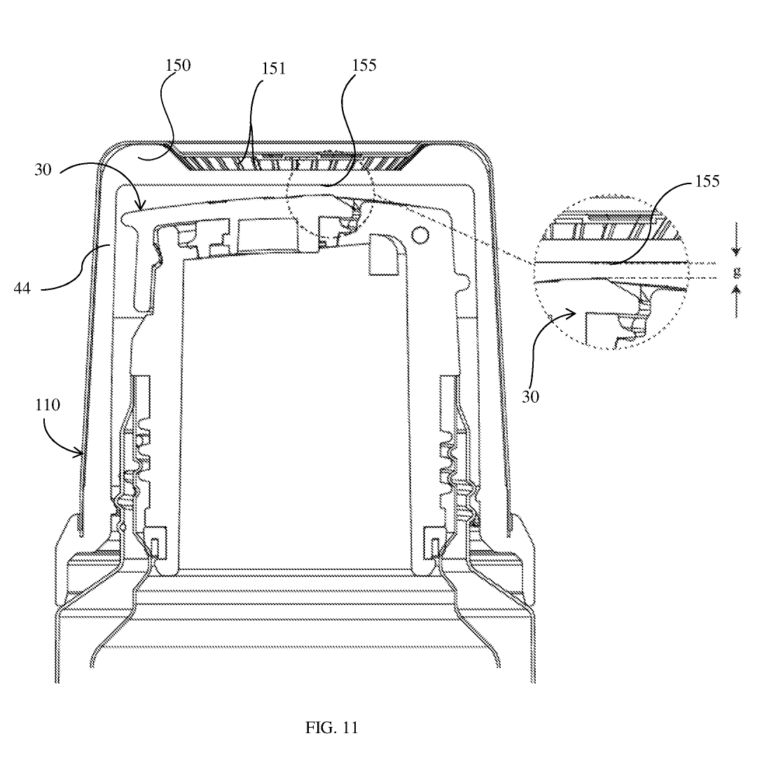

In an alternate embodiment depicted in FIGS. 9-11, a container 110 and a cup 112 correspond to the container 10 and the cup 12, respectively, as shown in FIGS. 1, 2, and 5. However, in the alternate embodiment of FIGS. 9-11, a surface 155 of the inner portion 44 is separated from the top of the cap 30 by a gap g of about 1.5 mm. In particular, by providing the gap g between the surface 155 and the top of the cap 30, it is possible to prevent overtightening of the cup 112 relative to the cap 30, and thus avoid possible damage to the cup 112 and/or cap 30.

Further, according to the alternate embodiment of FIGS. 9-11, instead of utilizing foam insulation, the cup 112 preferably includes a liner 150 including a plurality of channels 151. By use of a channel-insulated liner, insulation is arranged in a simplified manner without requiring the use of foam material and/or ultrasonic welding. Use of the channels 151 can result in a finned surface that may slow energy transfer between inner and outer walls of the cup 112.

Referring again to the embodiment depicted in FIGS. 1-8, a method of using the container 10 includes: providing the body 18 made of metal, which includes the inner and outer walls 14, 16, the body having a top and a bottom at opposite ends with the inner wall 14 forming the cavity 15 configured to receive fluid therein; removing the cup 12 from the container 10 by unscrewing the cup 12 from the body 18, so as to remove the cup 12 from blocking or obstructing access to the cap 30, thereby exposing the lid portion 20 of the container 10, the lid portion 20 being in fluid communication with the top of the body 18; and actuating the cap 30 arranged on the lid portion 20, the cap 30 configured to be actuated from a closed state to an open state with the cup 12 removed from the body 18, such that in the open state of the cap 30, the fluid can enter or exit the body 18. In the open state, fluid may be accessed through the opening 32 in the lid portion 20, where the opening 32 conforms to a user's mouth to facilitate drinking. The fluid also may be poured from the container 10 into the cup 12, and the cup 12 may be gripped via the outer portion 46 and the tapered area 56 to facilitate drinking. The fluid contained within the cup 12 may be kept warm or cold via the foam insulation housed between the inner and outer portions 44, 46.

Although specific materials are mentioned above, any and all portions of the lid portion 20 including the cup 12 as described herein may be made of any suitable material such as, but not limited to, plastic, metal, ceramic, or combinations thereof. Plastics of the present disclosure may include, for example, polyethylene terephthalate (PET), high density polyethylene, low density polyethylene, vinyl, polypropylene, and polystyrene. Additionally, suitable metals of the present disclosure may include aluminum and iron (e.g., steel, stainless steel, and cast iron). Any seal herein disclosed may be made of any suitable sealing material such as, but not limited to rubber, plastic, soft plastic and/or foam.

Accordingly, the lid portion 20 including the cup 12 as disclosed herein features a drink-through design that combines leak-proofness and insulation. A pivoting closure mechanism reversibly seals an opening in the lid portion to eliminate leaks through the opening. Foam insulation or a liner may be arranged in a hollow body of the cup to insulate the contents of the cup. Further, the cup may contact the lid portion when the cup is engaged with a body of the container. Alternatively, a gap may be formed between an inside of the cup and the cap to prevent overtightening of the cup. In either case, it is possible to prevent leakage of fluid within a container while also preserving the temperature of said fluid. The disclosed cup also features a thread pattern which may be fashioned to face inwardly with respect to the body of the container, so as to couple with an outwardly facing thread pattern of the body, thereby creating a tight seal that increases leak prevention and maintains insulative properties of the container.

While there have been shown and described illustrative embodiments that provide for a leak-proof container, it is to be understood that various other adaptations and modifications may be made within the spirit and scope of the embodiments herein. For example, the embodiments have been primarily shown and described herein with relation to a pivoting closure mechanism that rotates between an open and closed position. However, the embodiments in their broader sense are not as limited, as the closure mechanism may be replaced with another mechanism capable of sealing the lid opening, such as a push-button mechanism or a slide mechanism. Thus, the embodiments may be modified in any suitable manner in accordance with the scope of the present claims.

### EQUIVALENTS

Although preferred embodiments of the disclosure have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A vacuum insulated container, comprising:
a body made of metal having inner and outer walls with a vacuum formed between the inner and outer walls, the body having a top and a bottom defined at opposite ends, the inner wall forming a cavity configured to receive fluid therein;
a lid portion in fluid communication with the top of the body, the lid portion having a cap configured to be actuated between an open state and a closed state, such that in the open state, the fluid can enter or exit the body; and
a removable cup being connected to the body so as to cover the lid portion and maintain the cap in the closed state.

2. The vacuum insulated container of claim 1, wherein the cap is a flip-top cap configured to be toggled manually between the open and closed states.

3. The vacuum insulated container of claim 2, wherein upon removal of the cup from the container, the cap is configured to be opened or closed.

4. The vacuum insulated container of claim 2, wherein the cap is configured to pivot relative to a remainder of the lid portion so as to engage or release a latch mechanism.

5. The vacuum insulated container of claim 2, wherein in the open state of the cap, an opening of the lid portion is uncovered to enable entry or exit of the fluid in the body, the opening having a shape that facilitates pouring or drinking from the opening.

6. The vacuum insulated container of claim 5, wherein the opening is semicircular in shape.

7. The vacuum insulated container of claim 1, wherein the body is made of stainless steel, and the lid portion is connected to the body via a threaded connection.

8. The vacuum insulated container of claim 7, wherein the lid portion includes external threads configured to engage with internal threads of the body.

9. The vacuum insulated container of claim 1, wherein the cup is configured to be threaded to the body.

10. The vacuum insulated container of claim 9, wherein the cup includes inner threads and a rim, the inner threads configured to engage with corresponding outer threads of the body, and the rim configured to contact a surface of the body.

11. The vacuum insulated container of claim 1, wherein the cup is configured to be threaded to the body such that at least a portion of an inner surface of the cup contacts an upper surface of the cap so as to maintain the cap in the closed state.

12. The vacuum insulated container of claim 1, wherein the cup is foam insulated.

13. The vacuum insulated container of claim 1, wherein the cup includes a liner incorporating a plurality of channels.

14. A method of using a vacuum insulated container, comprising the steps of:
providing a body made of metal having inner and outer walls with a vacuum formed between the inner and outer walls, the body having a top and a bottom defined at opposite ends, the inner wall forming a cavity configured to receive fluid therein;
removing a cup from the container by unscrewing the cup from the body, so as to remove the cup from blocking access to the cap, thereby exposing a lid portion of the container, the lid portion being in fluid communication with the top of the body; and
actuating a cap arranged on the lid portion, the cap configured to be actuated from a closed state to an open state with the cup removed from the body, such that in the open state of the cap, the fluid can enter or exit the body.

15. The method of claim 14, wherein the cap is connected to the lid portion by a hinge on one side, and includes a latch mechanism on an opposite side of the hinge.

16. The method of claim 14, wherein in the open state of the cap, an opening of the lid portion is uncovered to enable entry or exit of the fluid in the body, the opening having a shape that facilitates pouring or drinking from the opening.

17. The method of claim 16, wherein the opening is semicircular in shape.

18. The method of claim 14, wherein the body is made of stainless steel, and the lid portion is connected to the body via a threaded connection.

19. The method of claim 18, wherein the lid portion includes external threads configured to engage with internal threads of the body.

20. The method of claim 14, wherein the cup is configured to be threaded to the body.

21. The method of claim 14, wherein the cup includes inner threads and a rim, the inner threads configured to engage with corresponding outer threads of the body, and the rim configured to contact a surface of the body.

22. The method of claim 14, wherein the cup is configured to be threaded to the body such that at least a portion of an inner surface of the cup contacts an upper surface of the cap so as to maintain the cap in the closed state.

23. The method of claim 14, wherein the cup is foam insulated.

24. The method of claim 14, wherein the cup includes a liner incorporating a plurality of channels.
